(19) United States
(12) Patent Application Publication
(10) Pub. No.: US 2003/0113086 A1
(43) Pub. Date: Jun. 19, 2003

(54) Optical splitter module

(75) Inventors: Soon Nam Jun, San Leandro, CA (US); Jong Ha Moon, Gwangju (KR)

Correspondence Address: BAKER & BOTTS, 30 ROCKEFELLER PLAZA, NEW YORK, NY, 10112

(73) Assignee: UNICOM TECHNOLOGIES CO., LTD., Gwangju (KR)

(21) Appl. No.: 10/314,802

(22) Filed: Dec. 9, 2002

Related U.S. Application Data
(63) Continuation-in-part of application No. 10/082,977, filed on Feb. 25, 2002.

(30) Foreign Application Priority Data
Dec. 1, 2001 (KR) 2001-75587

(51) Int. Cl. G02B 6/36

(52) U.S. Cl. 385/135

(57) ABSTRACT

The present invention is an optical splitter module having couplers splitting signals transmitted through cables to which one or more optical connectors are attached. The optical splitter module further comprises an adaptor holder having a front surface and a rear surface. The optical splitter module maintains a plurality of optical adaptors therethrough such that the optical adaptors are exposed to the outside of the module. The optical splitter module further comprises a housing for maintaining couplers therein and which has a bottom and sidewalls upwardly extending from the bottom, and a cover positioned on the sidewalls to close an upper portion of the housing. The bottom of the housing is provided with a contact portion engaged to the rear surface of the adaptor holder. The cover further comprises a contact portion engaged with the rear surface of the adaptor holder. The height of the module is smaller than the sum of the thickness of the bottom of the housing, the thickness of the cover and the height of the optical adapters.

### RELATED APPLICATION

This application is a Continuation-In-Part of co-pending U.S. patent application Ser. No. 10/082,977, entitled “Optical Splitter Module”, filed on Feb. 25, 2002.

### FIELD OF THE INVENTION

The present invention relates to an optical splitter module comprising couplers for splitting optical signals transmitted via cables attached to optical connectors, which monitor a signal transmission in an optical network system. More particularly, the invention is an optical splitter module which is adapted to be of an overall slimmer size capable of reduced space mounting within a chassis, and providing increased processing capacity notwithstanding its compact, reduced size.

### BACKGROUND OF THE INVENTION

Conventional optical splitter modules contain a plurality of optical fiber couplers in a case and perform a transmission of a signal selected from optical signal group having a wavelength of 1310 nm or 1550 nm, or etc. The optical splitter module allows real time monitoring of the signal transmission between a service provider and a subscriber by splitting the optical signals, thus enabling prompt restoration and easy maintenance and repair of telecommunication jamming.

A conventional optical splitter module 10 shown in FIG. 1a has couplers attached with optical connectors and a case containing the couplers. The case comprises an adaptor holder 11 with optical adaptors attached thereto, a housing 12, and a cover 13 mounted on the housing.

As shown in FIG. 1b, the housing includes a front portion 14, a bottom portion 15 and sidewalls 16. An upper portion of the housing is shown, opened. The front portion 14 of the housing is formed by upwardly folding a portion extending from the bottom portion of the housing. The front portion 14 of the housing is provided with an opening 17 for mounting an adaptor holder (FIG. 1c, 11) with a plurality of optical adaptors attached thereto, and defines a front portion of the module when the adaptor holder is mounted on the module.

The adaptor holder 11 has a wrinkled portion with a plurality of alternately formed peaks and gullies and is inserted into opening 17 of the front portion of the housing. Both ends of the adaptor holder 11 are threaded into the front portion 14 of the housing.

The cover 13 is mounted on the opened upper portion of the housing, and thus, the adaptor holder 11 is inserted and mounted between the bottom portion 15 of the housing and the cover 13. A front edge of the bottom portion 15 of the housing 12 and a front edge of the cover 13, which are adjacent to the adaptor holder 11, are manufactured to be in a straight line.

According to the conventional optical splitter module, the front portion 14 of the housing is formed by upwardly folding a portion of the bottom portion 15 of the housing. Thus, the front portion 14 of the housing need to have an upper portion 18 and a lower portion 19, each generally having a height of more than 5 mm and extending transversely along the opening into which an adaptor holder, generally having a height of 15 mm, is inserted to support the adaptor holder. This increases the height of the front portion 14 of the housing generally up to about 27 mm, which results in problems such as increase in the overall height of the module 10. This, in turn, limits the number of modules that can be mounted within a chassis.

FIG. 2 shows a housing 12′ of another conventional optical splitter module. The housing 12′ does not require upper and lower portions (18 and 19 as shown in FIG. 1b) extending transversely along an opening of front portion 14′ of the housing. Thus, the height of the front portion 14′ of the housing 12′ can be somewhat reduced. However, as shown in the illustrated conventional module of FIG. 2, an adaptor holder is inserted and mounted between a bottom portion 15′ of the housing and cover.

Therefore, the height of the front portion of the housing is defined by adding the thickness of the bottom portion 15′ of the housing and the thickness of the cover, which are generally about 2 mm, to the height of the adaptor holder, which is generally about 15 mm. Therefore, it is impractical to manufacture the module with a lower height without downsizing the optical adaptor per se.

The adaptor holders in conventional optical splitter modules have the additional problem of being unable to securely and tightly hold the optical adaptor, because the adaptor holder is supported by only threading on both ends of the front portion 14, 14′ of the housings 12, 12′, and the middle portions of the adaptor holder are not fixed.

The present invention is intended to solve the problems of conventional optical splitter modules as described above.

### SUMMARY OF THE INVENTION

It is, therefore, an object of the present invention to provide an optical splitter module capable of improving the inserting capabilities of modules within a standard chassis by reducing the height of the optical splitter module.

A further object of the present invention to provide an optical splitter module adapted to be of an overall slimmer size capable of reduced space mounting within a chassis, and providing increased processing capacity despite its compact, reduced size.

Another object of the present invention is to provide an optical splitter module capable of tightly securing an adaptor holder by engaging the middle portion of the adaptor holder with both the housing and a cover when the adaptor holder is mounted to the housing and the cover of the optical splitter module.

The above objects and other objects which will become apparent to one skilled in the art, are accomplished with the inventive optical splitter module which has couplers splitting signals transmitted through cables to which one or more optical connectors are attached. The optical splitter module comprises an adaptor holder having a front surface and a rear surface. The optical splitter module keeps a plurality of optical adaptors therethrough such that the optical adaptors are exposed out of the module. The optical splitter module further comprises a housing for the couplers, and it has a bottom and sidewalls upwardly extending from the bottom, and a cover positioned on the sidewalls to close an upper portion of the housing. The bottom of the housing is provided with a contact portion engaged with the rear surface of the adaptor holder. The cover further comprises a contact portion engaged to the rear surface of the adaptor holder. The height of the optical splitter module is smaller than the sum of the thickness of the bottom of the housing, the thickness of the cover and the height of the optical adapters.

### BRIEF DESCRIPTION OF DRAWINGS

FIG. 1 is a perspective view of a conventional optical splitter module.

FIG. 1b shows a top planar view and an elevational view of the housing of the conventional optical splitter module shown in FIG. 1a.

FIG. 1c is a top planar view and an elevational view of the adaptor holder of the conventional optical splitter module shown in FIG. 1a.

FIG. 2, which is similar to FIG. 1b, is a top planar view and an elevational view of a housing of another conventional optical splitter module.

FIG. 3 is a perspective view of the optical splitter module according to the present invention.

FIG. 4 is an exploded perspective view of the optical splitter module shown in FIG. 3.

FIG. 5 is a top planar view and an elevational view of the adaptor holder of the optical splitter module shown in FIG. 3.

FIG. 6 is a top planar view and an elevational view of the housing of the optical splitter module shown in FIG. 3.

FIG. 7 is a top planar view and an elevational view of the cover mounted on the housing of the optical splitter module shown in FIG. 3.

FIG. 8 is a top planar view of a housing of the optical splitter module according to a second embodiment of the present invention.

FIG. 9 is a top planar view of a cover for the optical splitter module according to the second embodiment of the present invention.

FIG. 10 is a top planar view and an elevational view of the adaptor holder of the optical splitter module according to the second embodiment of the present invention.

FIG. 11 is a perspective view of a standard chassis for which the inventive optical splitter module may be adapted to.

FIG. 12a is a perspective view of the optical splitter module in accordance with the third embodiment of the present invention.

FIG. 12b is a top planar view of the inventive optical splitter module shown in FIG. 12a, with its cover removed.

FIG. 12c is a front elevational view of the inventive optical splitter module shown in FIG. 12a.

FIG. 13a is a top planar view of the housing of the optical splitter module of the third embodiment of the present invention showing no internal components for clarity.

FIG. 13b is a front elevational view of the housing shown in FIG. 13a.

FIG. 14a is a top planar view of the cover of the optical splitter module of the third embodiment of the present invention.

FIG. 14b is a front elevational view of the cover shown in FIG. 14a.

FIG. 15a is a top planar view of the adaptor holder of the optical splitter module of the third embodiment of the present invention.

FIG. 15b is a front elevational view of the adaptor holder shown in FIG. 15a.

FIG. 16 is a front elevational view of a chassis equipped with the optical splitter module in accordance with the third embodiment of the present invention.

### DETAILED DESCRIPTION OF THE PRESENT INVENTION

Preferred embodiments of the present invention will now be described with reference to the accompanying drawings.

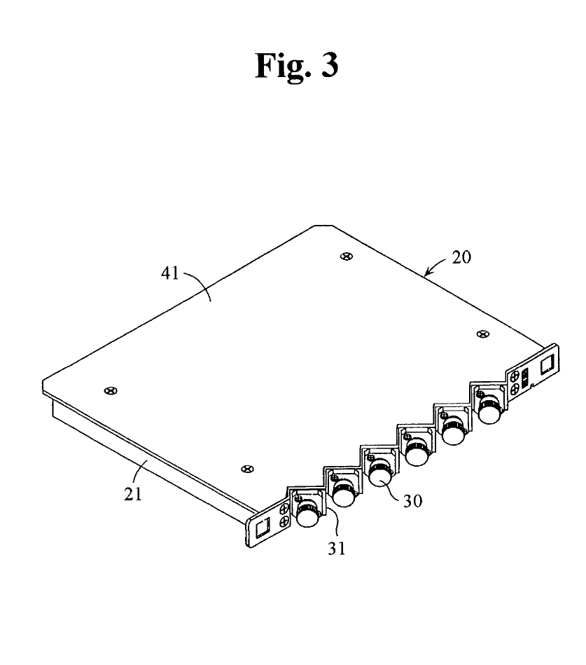

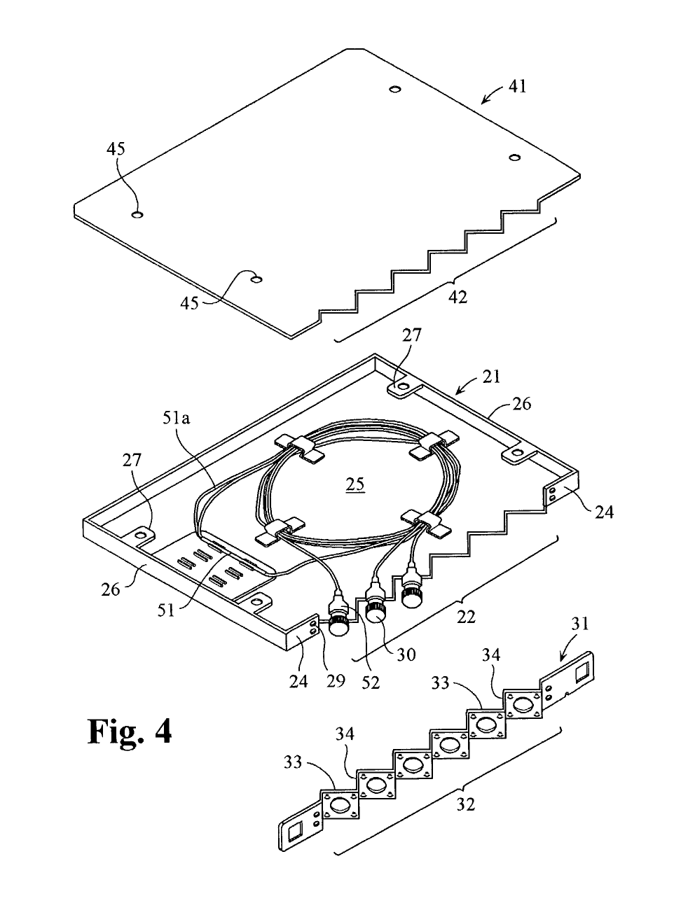

With reference to FIGS. 3 and 4, the optical splitter module 20 of the present invention comprises a plurality of couplers splitting signals transmitted via cables 51a attached to optical connectors 52 and a housing 21 containing the couplers 51. The module 20 comprises an adaptor holder 31 holding a plurality of optical adaptors 30, a housing 21, and a cover 41.

Referring to FIG. 4, the housing 21 of the present invention comprises a bottom portion 25 and sidewalls 26. The upper portion of the housing is shown opened. A fixing portion 24 for fixing the adaptor holder 31 thereto is integrally formed on a front portion of the housing. The housing 21 contains a plurality of couplers 51 splitting signals transmitted through the cables 51a attached to the optical connectors 52. The cover 41 is mounted on sidewalls 26 of the housing. The front edge of a bottom portion 25 of housing 21 and the front edge of the cover 41, which are engaged with the adaptor holder 31, have toothed portions 22, 42 formed therein. Each of the toothed portions has peaks and gullies corresponding to peaks and gullies of a wrinkled portion 32 of the adaptor holder 31, respectively.

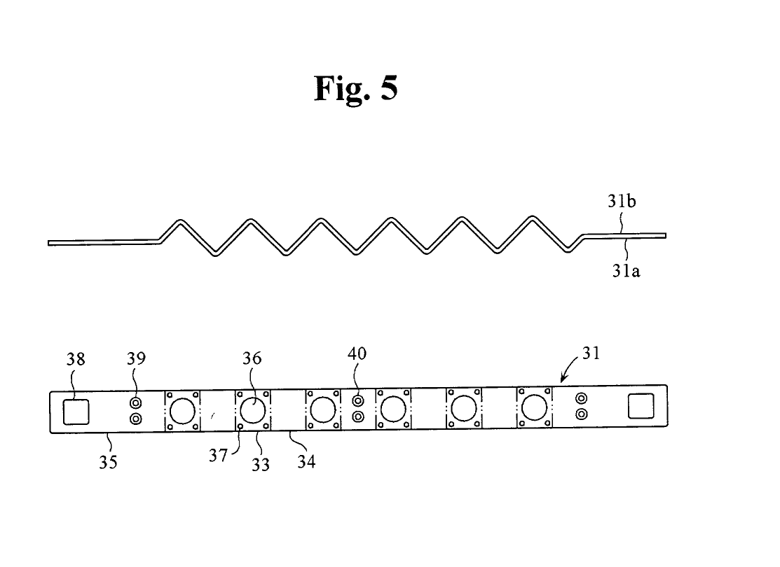

With reference to FIGS. 4 and 5, the adaptor holder 31 of the present invention comprises a front surface 31a and a rear surface 31b together with the wrinkled portion 32. The wrinkled portion 32 has a predetermined height and a plurality of peaks and gullies alternately formed along a longitudinal direction, wherein the peak protrudes toward the front surface 31a, while the gully protruding toward the rear surface 31b. A plurality of optical adaptors 30, each electrically connected to the optical connectors 52, are inserted and mounted into the adaptor holder 31.

It is preferable that the height of the adaptor holder 31 is the same as or smaller than that of the optical adaptor 30.

Preferably, a plurality of optical adaptors 30 is fixed on the adaptor holder 31 via a thread engagement. For this purpose, adaptor insertion holes 36 for accommodating and supporting the optical adaptors 30 and threaded holes 37 for fixing the optical adaptor 30 to the adaptor holder 31 are provided on the portion 33 of the adaptor holder 31 where the respective optical adaptors 30 are mounted.

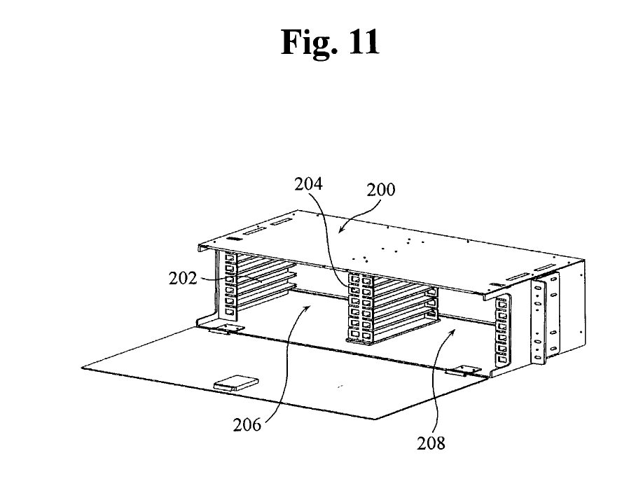

Both ends of the adaptor holder 31 are provided with handle portions 35 having mounting apertures 38 and holes 39, which are used when mounting the optical splitter module within a chassis 200 as shown in FIG. 11. The holes 39 of the handle portions correspond to threaded holes 29 of the fixing portions 24 of the housing, whereby the adaptor holder 31 is fixed to the fixing portions 24 of the front of the housing by threaded engagement through the holes 29, 39.

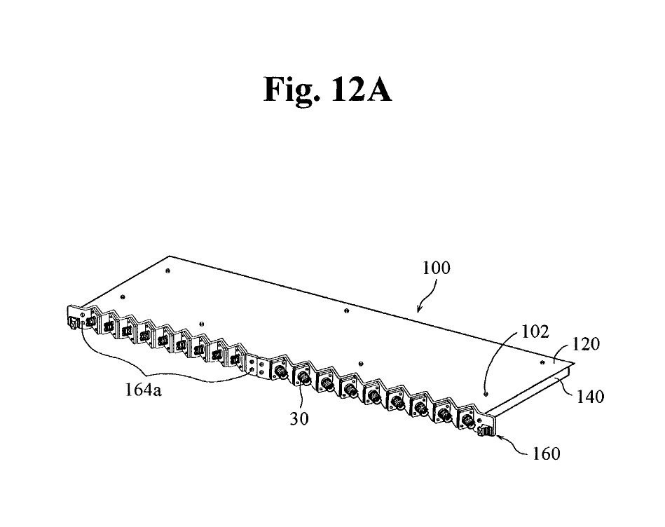

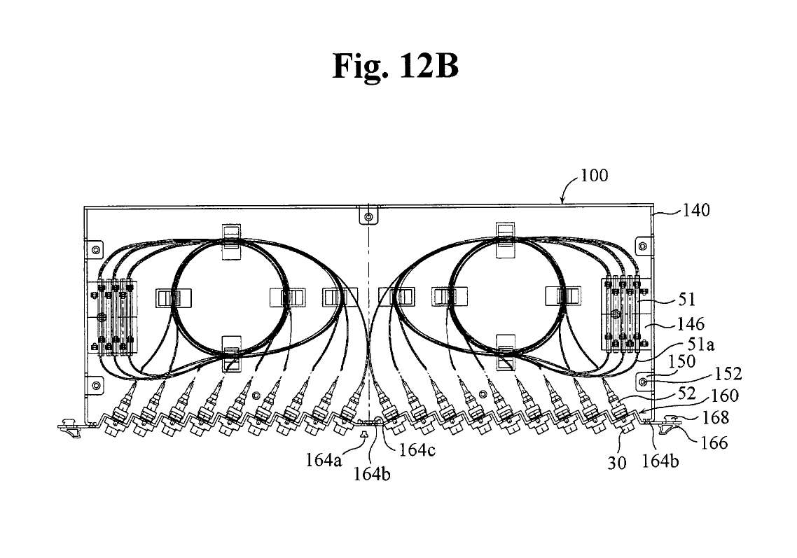

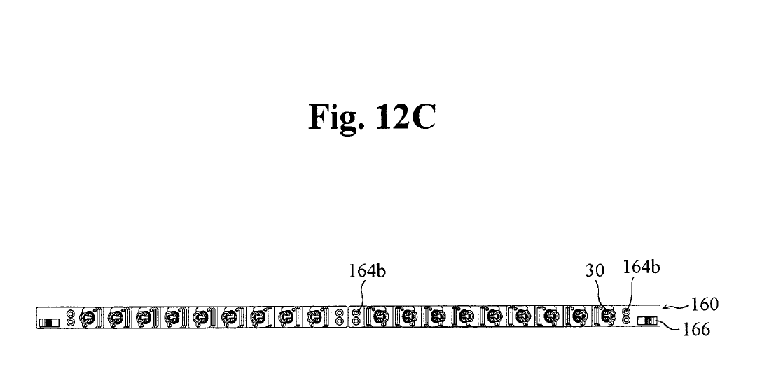

A locking member may be provided to the mounting apertures 38 in order to lock the module 20 within the chassis. One exemplary locking member is shown in FIG. 12b with designated with reference numerals 166 and 168.

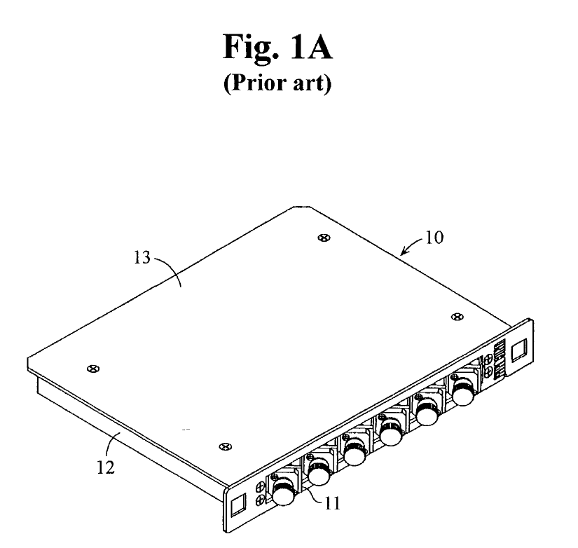

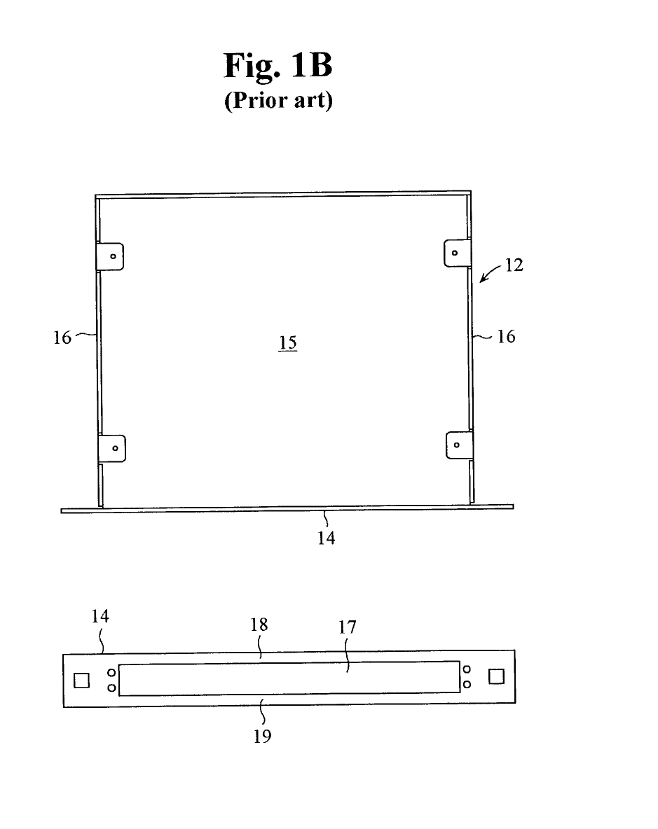

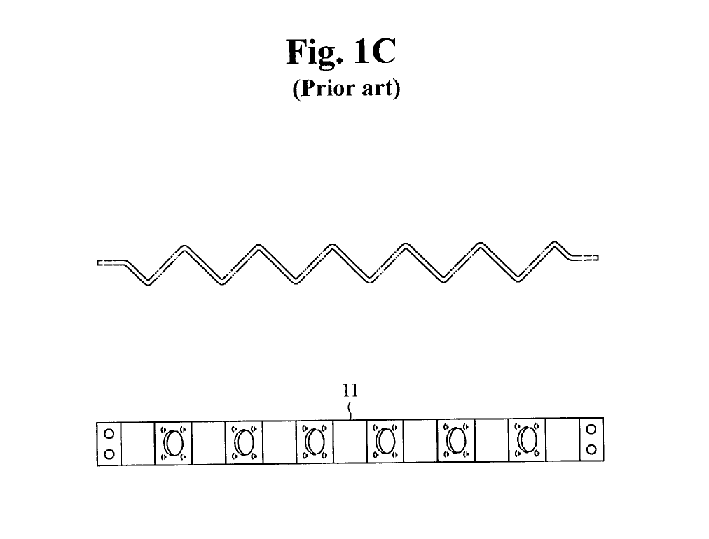

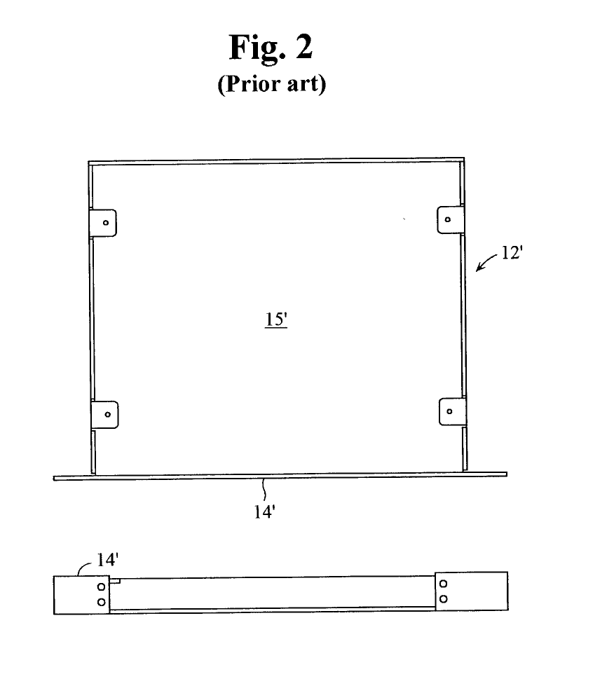

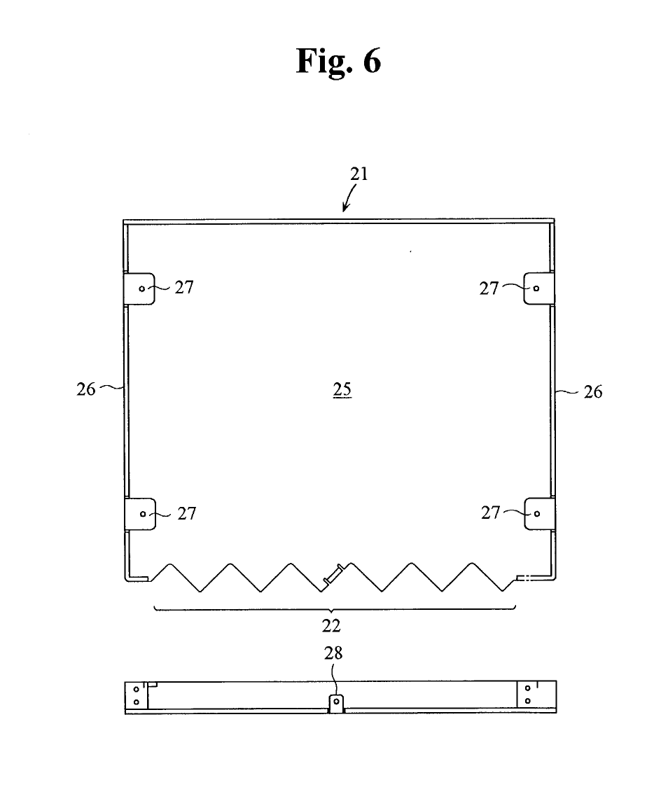

With reference to FIGS. 4 and 6, the housing 21 of the present invention is formed with the toothed portion 22 on the front edge of the bottom portion 25, which engages the wrinkled portion 32 of the adaptor holder 31. Since the adaptor holder 31 forms a frontal portion of the housing 21, portions like the portions of the prior art housing (18 and 19 of FIG. 1b) that extend along the opening of the front portion of the housing, are not needed and therefore the height of the housing can be reduced.

Referring to FIGS. 5 and 6, extended on the sidewalls 26 of the housing are a plurality of tabs 27, each tab having a threaded hole for mounting the cover 41 by threaded engagement. A tab 28 having a threaded hole is formed on a surface of the toothed portion 22 that corresponds to a surface 34 of the wrinkled portion 32 through which the optical adaptor 30 is not mounted. The tab 28 assures secure engagement between the adaptor holder 31 and the housing 21 by engaging the tab 28 with a hole (40, FIG. 5) formed on the wrinkled portion 32 by a thread. Therefore, the generation of a large gap or a shaking on the middle part of the optical splitter module is prevented.

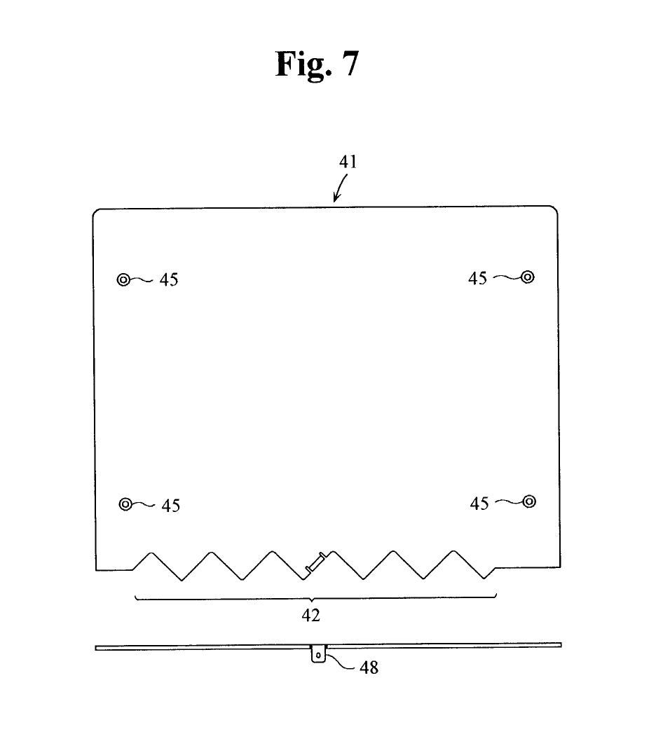

The cover 41 shown in FIG. 7 is mounted on the upper portion of the housing 21, and preferably threaded therebetween. For this purpose, the cover 41 is provided with holes 45 corresponding to the threaded holes of the tabs 27 formed on the sidewalls 26 of the housing 21.

The front edge of the cover 41, which is adjacent to the rear surface 31b of the adaptor holder 31 when assembled, comprises the toothed portion 42 adapted to be engaged with the surfaces of the wrinkled portion 32 of the adaptor holder 31, in the same manner as the front edge of the bottom portion 25 of the housing 21.

In addition, a tab 48 is formed on the cover 41 and is joined to a hole (40, FIG. 5) of the wrinkled portion 32 of the adaptor holder 31. In other words, the tab 48 functions similarly to the tab 28 on the housing 21. Thus, the tab 48 assures that the adaptor holder 31 is firmly secured on the cover 41.

The angles of the peaks and gullies of the wrinkled portion 32 and the angles of the peaks and gullies of the toothed portions 22, 42 are selected so as to provide mounting convenience for the optical adaptor, while reducing the length of the adaptor holder. Preferably, the angles of the peaks and gullies of the wrinkled portion and the toothed portions are in the range of 80° to 100°.

In addition, it is preferable that the lengths of the two straight edges defining each peak and gully are of substantially identical length to provide convenience for mounting to the optical adaptor 30.

With further reference to FIGS. 3 and 4, the adaptor holder 31, the housing 21, and the cover 41 are assembled to form a case for the optical splitter module 20 of the present invention. The adaptor holder 31 defines a front portion of the housing when assembled.

As shown in FIGS. 3 and 4, the front edge of the bottom portion 25 of the housing 21 and the front edge of the cover 41 comprise the toothed portions 22, 42 corresponding to the peaks and gullies of the wrinkled portion 32 of the adaptor holder 31. As such, unlike the prior art where the adaptor holder 31 is inserted between the bottom portion 25 of the housing and the cover 41, but the adaptor holder 31 is mounted to the housing 21 in such a manner that the adaptor holder 31 is contacted with at its rear surface 31b the front edge (23) of the bottom portion 25 of the housing 21 and the front edge 43 of the cover 41.

Therefore, when assembling the module, the adaptor holder 31, the housing 21 and the cover 41 can be securely engaged, assembled and fixed to one another by the respective wrinkled portions 32 and toothed portions 22, 42. Accordingly, the height of the front portion of the housing 21 does not exceed the height of the adaptor holder 31, and the overall height of the module 20 is the same as or smaller than the height of the optical adaptor 30 mounted on the adaptor holder 31. For instance, the height of the conventional module shown in FIG. 1, 27 mm, can be reduced to the height of the adaptor holder, 15 mm.

The above described optical splitter module 20 in accordance with the first embodiment of the present invention may be manufactured into two types of modules, i.e., a left type module and a right type module symmetrical to each other. The chassis 200 shown in FIG. 11 has two series of insertion slots 206, 208 and the left type modules and the right type modules are inserted into the corresponding insertion slots 206 and 208. A central fixture 204 is provided in a center of the chassis 200 to guide and support the insertion of the modules into the slots 206, 208.

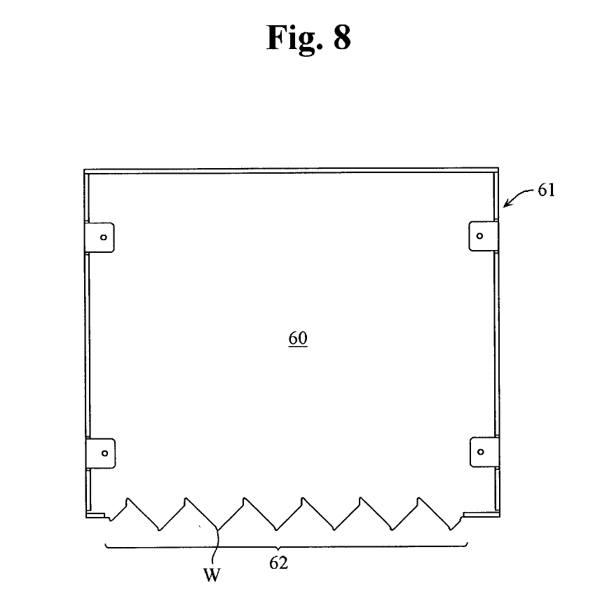

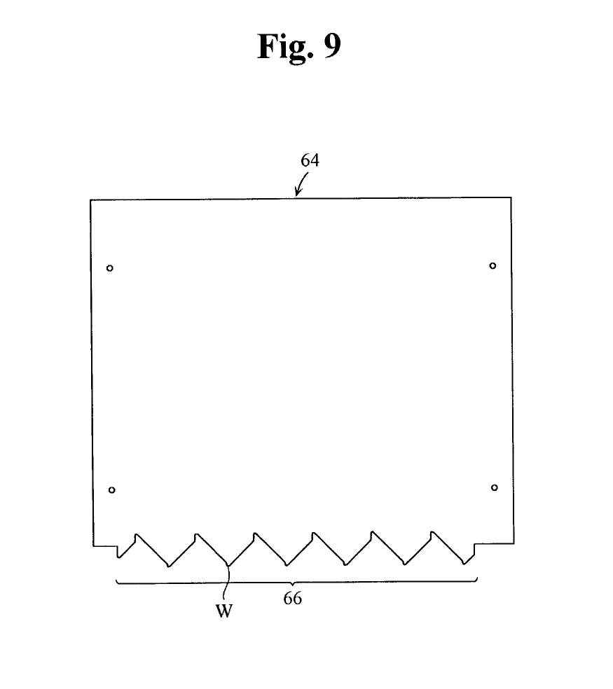

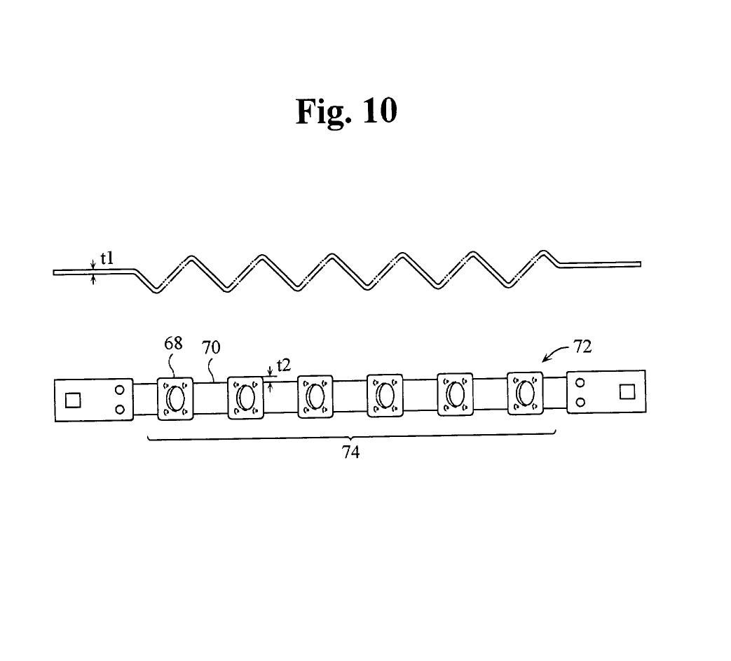

The second embodiment according to the present invention will be described with reference to FIGS. 8, 9 and 10. As with the first embodiment, the front edge of a bottom portion 60 of a housing 61 and a front edge of a cover 64 comprise toothed portions 62, 66 corresponding to peaks and gullies of a wrinkled portion 74 of an adaptor holder 72. Each of the toothed portions 62, 66 formed on the front edges of the housing 61 and the cover 64 has a projection portion 68 to be extended to a width W, equal to the thickness t1 of the adaptor holder 72 in order to cover the thickness of the adaptor holder 72.

In the peaks and gullies of the wrinkled portion 74 of the adaptor holder 72, the heights of portions 70 on which optical adaptors are not mounted are reduced by a thickness t2 that is the same as the width W of the projection portion. Accordingly, when the wrinkled portion 74 of the adaptor holder 72 is engaged with the toothed portions of the housing 61 and the cover 64, the adaptor holder 72 can be inserted between the toothed portions of the housing 61 and the cover 64. As such, the adaptor holder 72 can be securely assembled and avoid displacement.

A third embodiment of the inventive optical splitter module is now described with reference to FIGS. 12a through 16. In the description, same reference numerals will be designated to the same components as those in the first embodiment and explanations therefor are omitted.

As shown in FIGS. 12a and 12b, the optical splitter module 100 in accordance with the third embodiment of the present invention is similar to two modules 20 of the first embodiment arranged side-by-side and connected to each other. In size, the optical splitter module 100 is slightly larger than the sum of the sizes of the two modules in accordance with the first embodiment. Preferably, the module 100 has a size adapted to fit a chassis having the specifications for the module 20 as shown in FIG. 11 after removing the central fixture 204 from the chassis. In other words, the space that the optical splitter module 100 takes up is substantially equal to the space that two optical splitter modules 20 and the central fixture 204 take up.

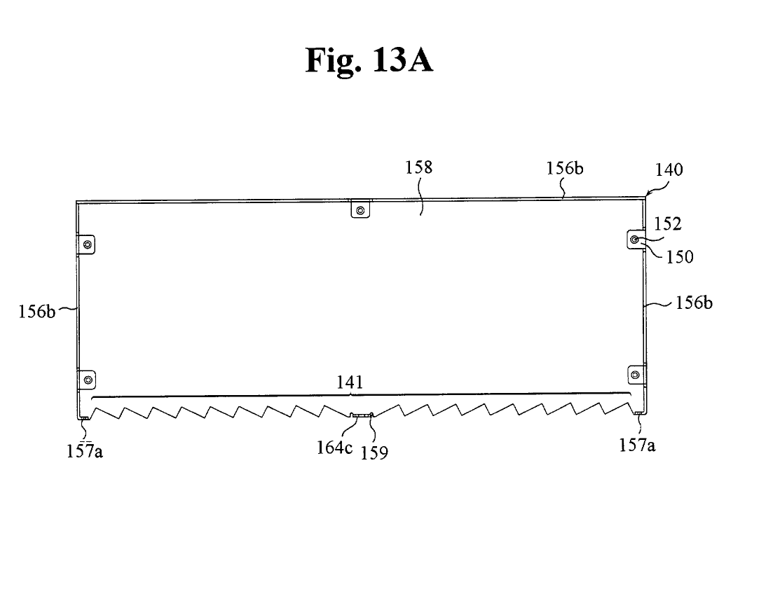

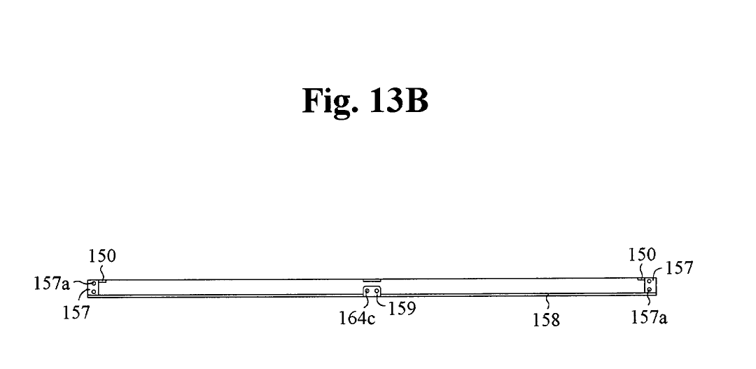

In FIG. 12b, the optical splitter module 100 is shown with its cover removed. Two coupler holders 146, two groups of optical connectors 154 and two groups of optical adaptors 162 are symmetrically arranged in the housing 140. As better illustrated in FIG. 13a with these components removed for clarity, the housing 140 is defined by a bottom portion 158 and sidewalls 156b upwardly extending from the bottom portion 158.

Formed on a front edge of the bottom portion 158 is a toothed portion 141 for be engagement with a wrinkled portion 172 of the adaptor holder 160 described below. Two straight edges 141a, 141b defining therebetween the peak and gullies of the toothed portion 141 are different in length from each other. A tab 159 protrudes from a center of the symmetrically configured toothed portion 141 for fixation with the adaptor holder 160 and a threaded hole 164c is formed through the tab 159.

In order to assemble the housing 140 with the cover 120, a plurality of tabs 150 protrude from the sidewalls 156b and a threaded hole 152 is formed through each of the tabs 150. Further, in order to assemble the housing 140 and the adaptor holder 160, threaded holes 157a are formed through a pair of fixing portions 157, respectively, which are formed on a front of the sidewalls.

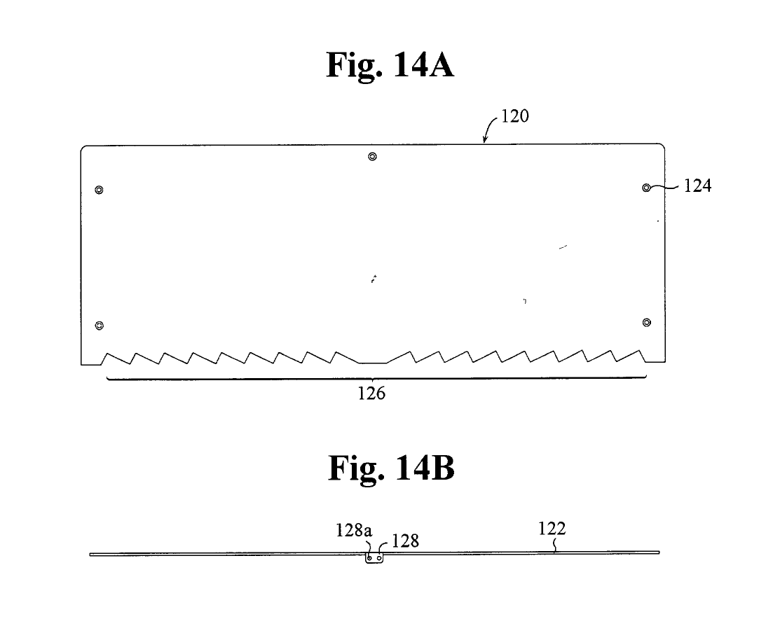

Referring to FIGS. 14a and 14b, the cover 120 functions to close the housing 140 at an upper side thereof and is provided with a toothed portion 122 at its front edge. The toothed portion 122 is the same in shape and size as the toothed portion 141. A plurality of threaded holes 124 corresponding to the threaded holes 152 of the housing 140, respectively, is formed through the cover 120. A tab 128 is also formed on the front edge of the cover 120 for fixation with the adaptor holder 160 and threaded holes 128a are formed through the tab 128.

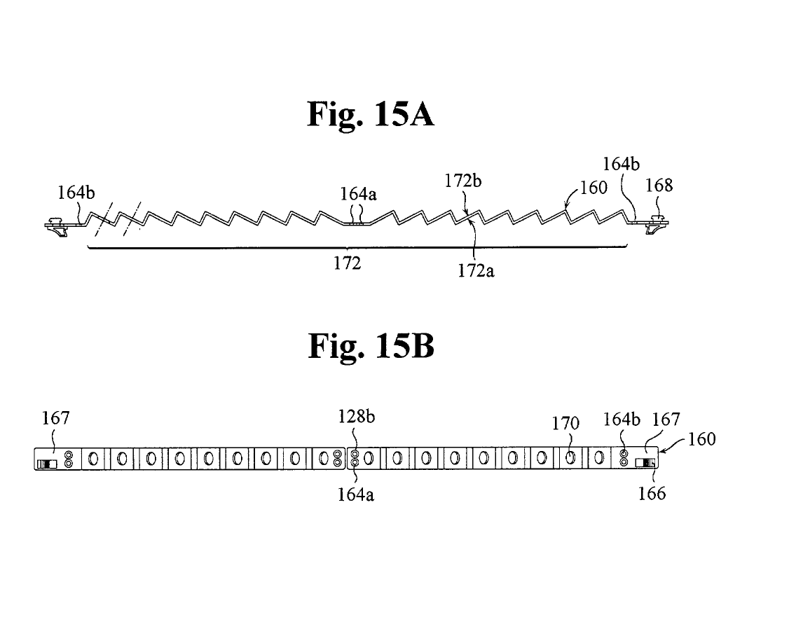

FIGS. 15a and 15b show the adaptor holder 160 having a front surface 172a and a rear surface 172b. The adaptor holder 160 is provided with the wrinkled portion 172 corresponding to the toothed portions 122, 141 and adapted to be engaged with the toothed portions 122, 141. The adaptor holder 60 is also provided with a pair of threaded holes 164b corresponding to the threaded holes 164c formed at the center of the housing 140, so that it is assembled onto the housing 140 via a thread 164a (see FIG. 12b), with a lower side of the wrinkled portion 172 being securely engaged with the toothed portion 141.

Further, the adaptor holder 160 is provided with threaded holes 128b corresponding to the threaded holes 128a formed at the center of the cover 120, so that it is assembled onto the cover 120 via the thread, with an upper side of the wrinkled portion 172 being securely engaged with the toothed portion 122.

As shown in FIG. 15b, the adaptor holder 160 has a plurality of adaptor insertion holes 170 for accommodating the optical adaptors 162 therethrough.

As shown in FIG. 12c, the wrinkled portion 172 of the adaptor holder 160 is symmetric about a center in a lengthwise direction of the adaptor holder 160. Further, the toothed portions 122, 141 have a symmetric configuration.

Formed at both lateral portions of the adaptor holder 160 are a sliding knob 166 and a latch 168 responsive to the movement of the sliding knob 166, which are used in locating the optical splitter module 100 into the chassis 200. The sliding knob 166 and the latch 169 are movable in the lengthwise direction of the adaptor holder 160, so that, at the end of inserting the module 100 into the chassis 200 after first locating the module 100 on the slot 206 or 208 of the chassis 200, the latch 168 is caught by a mating structure (not shown) formed on the slot 206 or 208 to have the module 100 anchored with respect to the chassis 200.

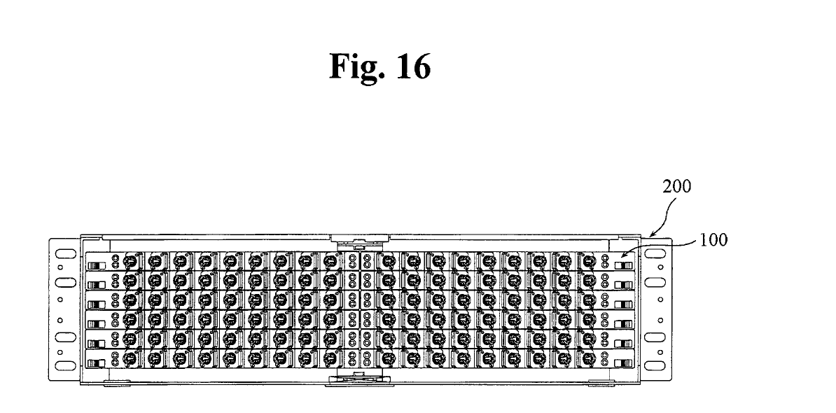

Shown in FIG. 16 is the chassis 200 equipped with the optical splitter module 100 in accordance with the third embodiment. For the insertion of the module 100 into the chassis 200, the central fixture 204 shown in FIG. 11 has to be removed from the chassis 200. For this reason, the optical splitter module 100 has a capacity larger than the capacity of the combined capacities of two optical splitter modules 20 in accordance with the first embodiment. In other words, the space taken up by the central fixture 204 is utilized to increase the capacity of the optical splitter module 100. Further, the space which common components in two optical splitter modules 20 takes up or common space in two optical splitter modules 20 can be saved when this widened module 100 is used.

Comparison of the capacity of one optical splitter module 100 with the capacities of two optical splitter modules 20, is provided below.

First, one optical splitter module 100 can accommodate a total of eighteen optical adaptors 162, with three of these used to perform both the transmission of the signal and the monitoring of the transmission, with respect to one independent line. Therefore, the optical splitter module 100 can provide a service for six independent lines.

On the other hand, one optical splitter module 20 has six optical adaptors therein and accordingly, two optical splitter modules 20 have twelve optical adaptors. Since three optical adaptors constitute a set for a service for one independent line, two optical splitter modules 20 can provide a service for four independent lines.

From the above, it can be understood that the optical splitter module 100 in accordance with the third embodiment can provide a service capacity increased by 50% than the added capacity of two optical splitter modules 20 of the first embodiment.

The optical splitter module according the present invention is manufactured in a small size wherein the height of the module is reduced to the level of the height of the adaptor holder itself, and a secure engagement between the adaptor holder and the housing is guaranteed. For instance, when the height of the conventional module, 27 mm, is reduced to the height of the adaptor holder, 15 mm, the stacking efficiency increases to 80% or more when stacking the module within the same chassis. Therefore, the costs associated with an additional chassis can be reduced and overall installation space can be saved by a new subscriber.

While the present invention has been shown and described with respect to particular embodiments, it will be apparent to those skilled in the art that many changes and modifications may be made without departing from the spirit and scope of the invention as defined in the appended claims.

What is claimed is:

1. An optical splitter module having couplers splitting signals transmitted through cables to which one or more optical connectors are attached, the optical splitter module comprising:
an adaptor holder having a front surface and a rear surface, the holder maintaining a plurality of optical adaptors therethrough such that the optical adaptors are exposed out of the module;
a housing for maintaining couplers therein, the housing having a bottom and sidewalls extending upward from the bottom, the bottom having a first contact portion engaged with said rear surface of said adaptor holder, and the sidewalls defining an upper portion of the housing; and
a cover positioned on said sidewalls for closing said upper portion of said housing, and the cover has a second contact portion engaged with said rear surface of said adaptor holder;
wherein the height of said optical splitter module is smaller than the sum of the thickness of said bottom of said housing, the thickness of said cover and the height of said optical adapters.

2. The optical splitter module of claim 1, wherein said adaptor holder further comprises a wrinkled portion with a plurality of peaks and gullies alternately formed along a lengthwise direction of said adaptor holder, wherein the peaks protrude towards said front surface and the gullies protrude towards said rear surface, and said contact portion of said bottom of said housing forms a toothed portion with a plurality of peaks and gullies corresponding to the peaks and the gullies of the wrinkled portion.

3. The optical splitter module of claim 1, wherein said adaptor holder further comprises a wrinkled portion with a plurality of peaks and gullies alternately formed along a lengthwise direction of said adaptor holder, wherein the peaks protrude towards said front surface and the gullies protrude towards said rear surface, and said second contact portion of said cover forms a toothed portion with a plurality of peaks and gullies corresponding to the peaks and the gullies of the wrinkled portion.

4. The optical splitter module of claim 2, wherein said wrinkled portion is disposed symmetric about the center of said adaptor holder along the lengthwise direction of said adaptor holder.

5. The optical splitter module of claim 3, wherein said wrinkled portion is disposed symmetric about the center of said adaptor holder along the lengthwise direction of said adaptor holder.

6. The optical splitter module of claim 4, wherein angles between said peaks and gullies of said wrinkled portion are in the range of 80° to 100° and the lengths of each of the two straight edges which form each said peaks and gullies are different from each other.

7. The optical splitter module of claim 5, wherein angles between said peaks and gullies of said wrinkled portion are in the range of 80° to 100° and the lengths of each of the two straight edges which form each said peaks and gullies are different from each other.

8. An optical splitter module having couplers splitting signals transmitted through cables to which one or more optical connectors are attached, the optical splitter module, comprising:
an adaptor holder having a front surface and a rear surface and maintaining a plurality of optical adaptors therethrough such that the optical adaptors are exposed out of the module, the adaptor holder having a wrinkled portion with a plurality of peaks and gullies alternately formed along a lengthwise direction of the adaptor holder, wherein the peaks protrude towards the front surface and the gullies protrude towards the rear surface of the adaptor holder;
a housing for maintaining couplers therein, the housing having a bottom and sidewalls extending upward from the bottom, the bottom having a toothed portion engaged with said wrinkled portion at said rear surface of said adaptor holder, and the sidewalls defining an upper portion of the housing; and
a cover positioned on said sidewalls to close said upper portion of said housing and having a toothed portion engaged with said wrinkled portion at said rear surface of said adaptor holder;
wherein the height of said optical splitter module is smaller than the sum of the thickness of said bottom of said housing, the thickness of said cover and the height of said optical adapters.

9. The optical splitter module of claim 8, wherein at least one hole is formed on said wrinkled portion of said adaptor holder, and tabs with threaded holes are formed on positions corresponding to the positions of said at least one hole of said adaptor holder on a front edge of said housing or a front edge of said cover.

10. The optical splitter module of claim 8, wherein each of said peaks and said gullies of said toothed portions of said housing and said cover has a projection portion adapted for extension by a thickness of said adaptor holder such that said adaptor holder is mounted on said projection portions of said toothed portions.

11. The optical splitter module of claim 8, wherein said wrinkled portion is disposed symmetric about the center of said adaptor holder along the lengthwise direction of said adaptor holder

12. The optical splitter module of one of claim 8, wherein angles between said peaks and gullies of said wrinkled portion are in the range of 80° to 100° and the lengths of each of the two edges forming each said peaks and gullies are substantially identical.
